(19) United States
(12) Patent Application Publication
(10) Pub. No.: US 2004/0110526 A1
(43) Pub. Date: Jun. 10, 2004

(54) Apparatus having a display device

(76) Inventor: Rainer Volland, Muenchen (DE)

Correspondence Address: BELL, BOYD & LLOYD, LLC, P. O. BOX 1135, CHICAGO, IL, 60690-1135, US

(21) Appl. No.: 10/257,628

(22) PCT Filed: Jan. 16, 2001
(86) PCT No.: PCT/DE01/00158

(30) Foreign Application Priority Data
Apr. 13, 2000 (DE) 10018375.1

(51) Int. Cl. H04M 1/00

(52) U.S. Cl. 455/550.1; 455/575.1

(57) ABSTRACT

The invention relates to a unit provided with a display device and with a housing or housing part that can be changed by the user. The inventive unit comprises means for recognizing the housing or housing part situated thereon. The unit also comprises a control, which controls the display device according to the respective housing or housing part situated on the unit. The invention also relates to a corresponding method for controlling a display device of such a unit.

The invention relates to an appliance having a display device and a casing or casing part which can be interchanged by the user. The invention also relates to a method for controlling a display device on such an appliance.

A few currently available electronic mobile appliances, for example certain types of mobile telephones, allow the user to interchange the casing or parts of the casing. This is frequently a kind of top cover which can be fitted onto the appliance's subchassis and removed again. This is intended to allow the user to tailor the appliance according to his taste or to his required use, for example indoor or outdoor use. Such an appliance often comes with various casing types already. In addition, various casing types can be purchased subsequently.

The display device, for example the normal display with the user interface (the “MMI”; man-machine interface) on mobile telephones, is generally not interchanged in the process, however. Since a display is a relatively expensive component of the appliance, cost reasons usually mean that it is not appropriate to interchange it. If the display is enclosed by the interchangeable casing or casing part, then the latter has a corresponding cutout for the display at the position of the display.

It is an object of the present invention to provide an alternative to the known prior art.

This object is achieved by an appliance in accordance with claim 1 and by a method in accordance with claim 10.

On the basis of the invention, the appliance has means for identifying the casing or casing part which is on the appliance. That is to say the type of casing or casing part is automatically recognized or identified in this way when the user interchanges the casing or casing part. On the basis of the type of casing or casing part, an appropriate controller in the appliance is then used to actuate the display device. This allows the user interface on the display to be automatically adjusted when the casing is interchanged.

Thus, by way of example, when the casing alters the design or color of the appliance, the color or additional graphical elements of the user interface can be matched thereto. In this case, matching or adjusting the color and/or graphical representation of the user interface to the respective casing does not necessarily mean that the background of the user interface is made the same color as the casing, but rather refers in this respect to any adjustment regarding taste which pleases the respective user.

Preferably, the appliance has appropriate means so that the user can himself select for the respective casing how the associated matching user interface is configured.

Besides for purely visual adjustment, the invention can also be used to allow a particular service which works only with a particular casing or casing part to be automatically activated. In particular, the interchangeable casing or casing part can comprise a special functional element for this purpose. Such a functional element can be, by way of example, an input and/or output element, for example an additional alphanumeric keypad, a camera or an additional loudspeaker. It is also possible for the functional element to be a measuring element, for example an altimeter or pressure gauge, a temperature gauge, a sphygmograph, an accelerometer and speedometer, a pedometer or the like. Other functional elements in this context are also more complex supplementary appliances, such as an MP3 player or the like.

When such a casing or casing part is fitted, the appliance automatically identifies the respective functional element and actuates the display device such that the user interface automatically displays information related to the functional element.

By way of example, when a casing having an additional thermometer is used, the temperature can thus be displayed or a service associated with the additional functional element can be presented for activation.

Another option is for a service provider to provide the users of mobile telephones with a casing having a special key printed with the service provider's own logo. When this casing is fitted on the appliance, the casing is automatically identified, and pressing the special key calls up a menu directly in which all the services provided by the respective service provider can be called up.

It goes without saying that the interchangeable casing or casing part must in this case have not only a functional element but also a corresponding interface, so that the appliance can communicate with the functional element.

It also goes without saying that, on the basis of the added functional element, the controller can be used to assign particular functions, if appropriate, to the already existing keypad or to the softkeys on the appliance.

In one particularly simple exemplary embodiment, the means for identifying the casing or casing part have electrical or mechanically interacting contact elements arranged on the appliance and on the casing or casing part. These can be, by way of example, simple contact pins which, depending on the interchanged casing type, are either pressed down by the fitted casing or engage in a corresponding recess in the casing and are therefore not pressed down. When electrical contacts are used on the appliance, the casing or casing part has corresponding mating contacts, for example, so that, by way of example, quite specific contacts are grounded and others in turn are not.

The use of a plurality of such contacts or contact pins allows coding, so that these contact pins simultaneously serve as coding elements. By using, by way of example, three such pins or contacts arranged next to one another, a total of eight different casings or casing parts can be identified.

Alternatively, the means for identifying the casing or casing part can naturally also comprise optical or capacitive or inductive sensor elements which are arranged in the appliance or in the casing or casing part.

Another alternative involves a code store being arranged on the interchangeable casing or casing part, for example. The appliance then has appropriate means for reading the code store. In this context, as in the case of a chip card, the code store can be relatively small and can be accommodated so as to be flat in the casing, for example in a relatively thin top cover.

Naturally, the means for identifying the casing or casing part, particularly the electrical contacts or the means for reading the code store, can also simultaneously be used as an interface for communicating with any functional element which might be on the casing or casing part.

The invention can be used, in principle, in any electronic appliances having an appropriate display device and an interchangeable casing. However, the invention is used particularly preferably for mobile terminals, such as mobile telephones or cordless telephones, and PDAs (Personal Digital Assistants), such as organizers, palmtops or the like, since their portability means that these appliances frequently need to be matched to different uses or to different environments by the user.

The invention is explained in more detail below using exemplary embodiments with reference to the appended drawings. The features illustrated thereby and the features which have already been described above can be fundamental to the invention not just in the cited combinations but also individually or in other combinations. In particular, it will once again be pointed out at this juncture that all the features illustrated in relation to the appliance can also be fundamental to the invention with regard to the method for controlling a display device on such an appliance, and vice versa. In the drawings:

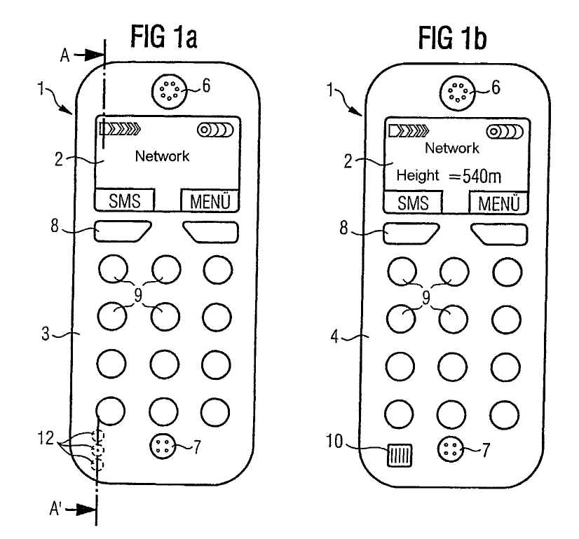

FIGS. 1a to 1c show an inventive mobile telephone with different configurations of the user interface when different top covers have been added;

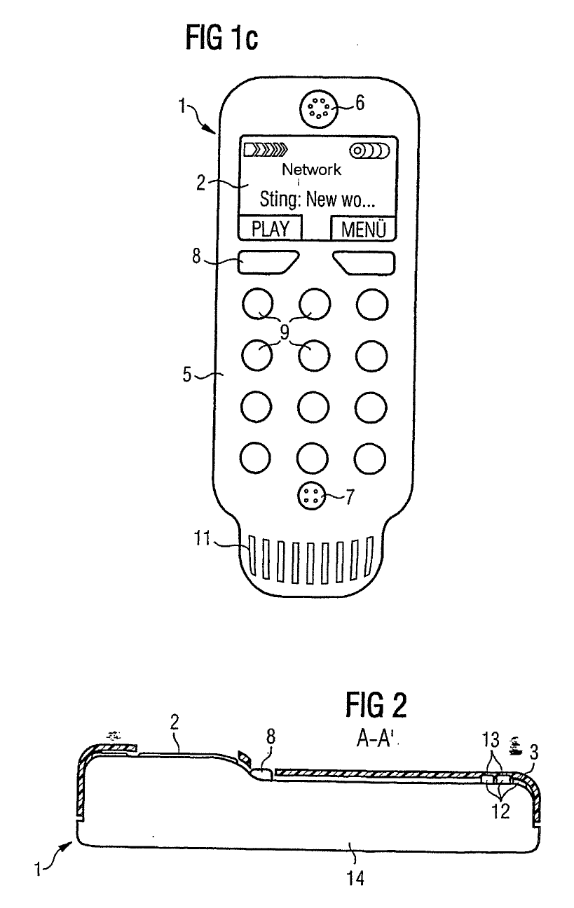

FIG. 2 shows a schematic sectional illustration through a mobile telephone having an interchangeable top cover.

FIG. 1a shows an inventive mobile telephone 1 which has an interchangeable top cover 3. Outwardly, this mobile telephone 1 equipped with a display 2, two softkeys 8, other keys 9, a microphone 7 and an earpiece 6 cannot be distinguished from a conventional mobile telephone, provided that a top cover without further supplementary elements or supplementary functions has been fitted.

FIG. 2 shows a schematic section along the sectional line A-A in FIG. 1 with a top cover 3 fitted on a subchassis 14, this top cover 3 not yet having been fixed firmly in the final position on the subchassis 14. In this side view, only the display 2 and the softkeys 8 below the display 2 are shown on the subchassis 14. The individual keys 9 on the keypad have not been shown for the sake of clarity.

In the lower region of the mobile telephone 1, there are three pushbuttons 12 on the subchassis 14. These pushbuttons 12 serve to identify the top cover 3 which has been fitted onto the subchassis 14. In this case, the identification is made by virtue of the top cover 3 pressing down particular pushbuttons 12 when the top cover 3 has been fitted. By contrast, other pushbuttons 12 are accommodated in depressions 13 in the top cover 3, said depressions being formed in the top cover 3 at the corresponding places. These pushbuttons 12 are thus not pressed down even when the top cover 3 has been fixed.

The arrangement of the depressions 13 in the top cover 3 thus allows a code to be transmitted to the mechanical pushbuttons 12, said code serving to identify the respective top cover type 3. Three such pushbuttons 12 and correspondingly arranged depressions 13 allow a total of 2³=8 different top cover types to be distinguished. This identification is particularly simple and inexpensive, since the respective depressions 13 can easily be formed during the process of injection molding the top cover 3. It is thus possible to provide, by way of example, eight differently colored top covers having different depressions, with the appliance respectively using the pushbuttons 12 to identify the top cover 3 or the associated color and, accordingly, to adjust, by way of example, the background color of the user interface on the display 2.

FIGS. 1b and 1c each again show the same mobile telephone as FIG. 1a, but with top covers 4, 5 having different functional elements 10, 11 now having been fitted.

FIG. 1b shows a top cover 4 having an altimeter 10. On the basis of the corresponding code in the top cover 3, this altimeter 10 is identified by the appliance 1, and a suitable interface (not shown) is used to forward the data recorded by the altimeter 10 to the appliance 1. The height measured by the altimeter 10 is then automatically indicated on the display. It is naturally possible for the buttons 12 also to be in the form of electrical contacts, if appropriate, and usefully to be simultaneously used as an interface for receiving the measured data from the altimeter 10.

It is naturally also possible to use any other interface and, by way of example, also to use this interface for identifying the casing or casing part (or in this case the top cover type).

In FIG. 1c, an MP3 recorder 11 having an additional loudspeaker has been incorporated in the top cover 5 as an additional functional element. As soon as the appliance 1 detects such a top cover 5 provided with an MP3 recorder 11, the user interface on the display 2 automatically presents appropriate functions for operating the MP3 recorder 11. Thus, in the exemplary embodiment shown, the left softkey 8 is automatically assigned the function “play” and, accordingly, the function of the softkey is also displayed on the user interface. In addition, the respectively playing track or interpret is displayed on the display. The MP3 recorder 11 is operated from the appliance, again using a suitable interface between the top cover 5 and the appliance 1.

The inventive appliance and the inventive methods can be used universally. Other options which can be cited for the incorporation of functions in casing covers are, by way of example, video games, which are automatically presented on the display provided that the casing has special control elements needed for this purpose. Similarly, a casing cover could have an extended alphanumeric keypad. Other options for measuring instruments are, by way of example, a thermometer or else an electronic range finder which operates using a laser or using an ultrasound method, for example.

A fundamental feature of all these exemplary embodiments is merely the automatic coupling of the alteration of the external appearance of the interchanged casing or casing part or of the function options prescribed by the respective casing or casing part to a corresponding alteration of the user interface on the display device.

1. An appliance (1) having a display device (2) and a casing or casing part (3, 4, 5) which can be interchanged by the user, characterized by means (12, 13) for identifying the casing or casing part (3, 4, 5) which is on the appliance (1) and a controller which actuates the display device (2) on the basis of the respective casing or casing part (3, 4, 5) which is on the appliance (1).

2. The appliance as claimed in claim 1, characterized in that the interchangeable casing or casing part (4, 5) comprises a functional element (10, 11).

3. The appliance as claimed in claim 2, characterized in that the functional element (11) comprises an input and/or output element.

4. The appliance as claimed in claim 2 or 3, characterized in that the functional element (10) comprises a measuring element.

5. The appliance as claimed in one of the preceding claims, characterized in that the means for identifying the casing or casing part (3, 4, 5) comprise electrically or mechanically interacting contact elements (12, 13) arranged on the appliance (1) and on the casing or casing part (3, 4, 5).

6. The appliance as claimed in one of the preceding claims, characterized in that the means for identifying the casing or casing part comprise optical and/or capacitive and/or inductive sensor elements.

7. The appliance as claimed in one of the preceding claims, characterized in that the means for identifying the casing or casing part (3, 4, 5) comprise coding elements (12, 13).

8. The appliance as claimed in claim 7, characterized by a code store which is on the interchangeable casing or casing part and means for reading the code store which are on the appliance.

9. The appliance as claimed in one of the preceding claims, characterized in that the appliance (1) is a mobile terminal (1) or a PDA.

10. A method for controlling a display device (2) on an appliance (1) which has a casing which can be interchanged, at least in part, by the user, characterized in that the interchangeable casing or casing part (3, 4, 5) is automatically identified and the display device (2) is actuated on the basis of the respective casing or casing part (3, 4, 5).

11. The method as claimed in claim 10, characterized in that the color and/or graphical representation of a user interface on the display device is matched to the casing or casing part.

12. The method as claimed in claim 10 or 11, characterized in that the interchangeable casing or casing part (3, 4, 5) comprises a functional element (10, 11), and the display device (2) is used for automatically representing information related to the functional element (10, 11).
